(19) United States
(12) Patent Application Publication
(10) Pub. No.: US 2005/0152016 A1
(43) Pub. Date: Jul. 14, 2005

(54) Optical pulse analyzer

(75) Inventors: Varda Herskowits, Petach-Tikva (IL); Menachem Tipris, Raana (IL)

Correspondence Address: William H. Dippert, Esq.;Reed Smith LLP, 599 Lexington Avenue, 29th Floor, New York, NY, 10022-7650, US

(73) Assignee: Aelis Photonics (Israel) Ltd., Netanya (IL)

(21) Appl. No.: 10/506,279

(22) PCT Filed: Mar. 4, 2002
(86) PCT No.: PCT/IL02/00165

(51) Int. Cl. G02F 1/00; G02B 26/00

(52) U.S. Cl. 359/237

(57) ABSTRACT

A method for characterizing optical pulses in a pulse train wherein pulses in the pulse train have substantially a same shape, the method comprising: a) detecting photons from pulses in the pulse train with a probability of detecting a photon per pulse being substantially less than one; b) determining a time lapse between detection of a first photon and a subsequent second photon and storing the time lapse in a memory; c) repeating b to accumulate a plurality of time lapses; and d) using the plurality of time lapses to characterize the pulses.

### FIELD OF THE INVENTION

The present invention relates to methods and apparatus for determining a power spectrum of an optical waveform and in particular to apparatus and methods for determining a power spectrum of a digital waveform encoding data in an optical signal.

### BACKGROUND OF THE INVENTION

An optical communication network transmits digital data between a transmitter and a receiver in the network in the form of pulses of light, usually representing zeros and ones, that are transmitted between the transmitter and receiver via an optical link comprising optical fibers. At a given transmission rate, pulses in a pulse train transmitted by the transmitter are transmitted during temporally contiguous, sequential periods of time, referred to as repetition periods, having substantially a same duration that is determined by the transmission rate. Each pulse in the pulse train is transmitted during its own pulse repetition period. At transmission, each pulse has a well-defined shape and a pulse width equal to or smaller than the pulse repetition period, as a result of which its optical energy is substantially confined to its repetition period.

However, as a pulse propagates through an optical fiber it generally suffers attenuation and dispersion as a result of interaction of the pulse with the material from which the fiber is formed. Attenuation reduces an amount of energy in a light pulse while dispersion redistributes the pulse's energy and generally temporally spreads the pulse. The attenuation and dispersion that a pulse suffers during propagation over a fiber can change the pulse shape and/or amplitude to a degree that makes it difficult to identify which digital symbol the pulse represents. In addition, often, dispersion spreads the energy of a pulse to such an extent that after propagating over a length of fiber, energy from a pulse in a pulse train transmitted by a transmitter in the network appears in repetition periods of other pulses in the pulse train. The energy of the pulse is no longer confined to its own repetition period but is spread out to repetition periods of other pulses and mixes with the energy of the other pulses. The mixing of optical energy from different pulses in a same given repetition period increases the difficulty in identifying the symbol that the pulse originally transmitted in the given repetition period is intended to represent. The mixing of energy that interferes with symbol identification is referred to as inter-symbol interference (ISI).

To maintain an acceptable quality of communication an optical communication network often monitors quality of optical pulses that are transmitted over various optical links in the network and may in response to the monitored quality compensate for and/or moderate attenuation and dispersion of the pulses. Methods and devices for determining a power spectrum of optical pulses are often used to monitor quality of optical pulses transmitted over an optical path. For data transmission rates up to about 10 Gbps, relatively effective devices and techniques, such as autocorrelators and autocorrelation techniques exist for determining and monitoring power spectra of optical pulses in an optical communication network.

However, for data rates approaching about 10 Gbps, autocorrelators for monitoring power spectra of optical pulses are relatively expensive. Furthermore, communication networks are planned that simultaneously support a variety of different transmission protocols providing data transmission rates from about 2.5 Gbps to transmission rates up to and in excess of about 40 Gbps. To support such communication networks methods and devices are required for characterizing power spectra of optical pulses transmitted at the transmission rates at which they operate.

### SUMMARY OF THE INVENTION

An aspect of some embodiments of the present invention relates to providing a method for determining a power spectrum of optical pulses transmitted in a train of pulses characterized by a pulse repetition period that are used to transmit data in an optical communication network.

An aspect of some embodiments of the present invention relates to providing apparatus, hereinafter referred to as a “pulse analyzer”, for determining a power spectrum of optical pulses in a train of optical pulses.

In some embodiments of the present invention, the pulse train transmits data at a data transmission rate approaching, or in excess of about 10 Gbps. In some embodiments of the present invention, the pulse train transmits data at a data transmission rate approaching, or in excess of about 40 Gbps. In some embodiments of the present invention, the pulse train transmits data at a data transmission rate approaching or in excess of about 160 Gbps.

A pulse analyzer, in accordance with an embodiment of the present invention, optionally comprises first and second photosensors, a light director and apparatus, hereinafter referred to as a clock for determining a length of a time interval. Each photosensor operates in a single photon detection mode and generates an output signal responsive to a single photon incident thereon. Photosensors known in the art, for example, certain types of avalanche photodiodes (APDs), metal-semiconductor-metal (MSM) photodiodes, or photomultiplier tubes (PMT) can be operated in a Geiger detection mode and can be used in the practice of the present invention. Such photosensors are readily available commercially and are relatively inexpensive.

To determine a power spectrum of optical pulses in a pulse train of pulses, in accordance with an embodiment of the present invention, first and second portions of the energy in each pulse of the pulse train are diverted by the light director to the first and second photosensors respectively. The portion of the energy diverted to each photosensor is determined so that a probability of more than one photon from any single pulse reaching either the first or the second photosensor is very small. When a first photon from a pulse in the pulse train is incident on the first photosensor, the photosensor generates a first signal at a first time that turns on the clock. The clock remains on until a second photon from an optical pulse in the pulse train is incident on the second photosensor. Responsive to the second photon, the second photosensor generates a second signal at a second time, which turns the clock off. The first and second times are used to define an “autocorrelation interval”, which is equal to the repetition period plus the second time modulo the repetition period minus the first time modulo the repetition period. The auto correlation interval is stored in a memory.

The clock is repeatedly turned on and turned off by photons from optical pulses in the pulse train until a large plurality of autocorrelaton intervals is accumulated. The number of the plurality is determined so that a probability density function (pdf) for the autocorrelation intervals can be defined to within a desired statistical accuracy. The probability density function is processed to determine a power spectrum that characterizes the optical pulses. Optionally, the power spectrum is processed to determine an autocorrelation function for the pulse train.

When a photosensor is operated in a Geiger mode, jitter and width of a signal generated by the photosensor responsive to a single incident photon incident thereon is generally determined substantially only by spread in a transit time of photoelectrons in the photosensor. For some photosensors the spread is very small and for a suitable Geiger mode photosensor, a time at which a photon is incident on the photosensor can be determined to a resolution of about a picosecond. As a result, relatively inexpensive, commercially available photonic components can be used in the practice of the present invention to characterize the power spectrum of optical pulses having pulse widths that are less than 10 picoseconds.

The method of determining the power spectrum, in accordance with an embodiment of the present invention, is generally substantially independent of a data transmission rate of the optical pulses up to a maximum transmission rate. The maximum transmission rate is determined generally by an accuracy with which a time interval between an arrival of a first photon and a second subsequent photon on a photosensor can be determined.

There is therefore provided in accordance with an embodiment of the present invention, a method for characterizing optical pulses in a pulse train wherein pulses in the pulse train have substantially a same shape, the method comprising: a) detecting photons from pulses in the pulse train with a probability of detecting a photon per pulse being substantially less than one; b) determining a time lapse between detection of a first photon and a subsequent second photon and storing the time lapse in a memory; c) repeating b to accumulate a plurality of time lapses; and d) using the plurality of time lapses to characterize the pulses.

Optionally, the pulse train is characterized by a constant pulse repetition period and each optical pulse is located in a same temporal position of its own repetition period.

Optionally, using the plurality of time lapses comprises determining a time interval for each time lapse, which time interval is equal to the time lapse minus a time equal to the repetition period times a number of repetition periods between the repetition periods of the pulses from which the first and second photons are detected and using the plurality of determined time intervals to characterize the pulses.

Optionally, using the plurality of time intervals comprises determining a probability density function for the time intervals. Optionally, the method comprises determining a Fourier transform of the probability function. Optionally, the method comprises using the Fourier transform to determine a power spectrum for the pulses. Optionally, the method comprises using the power spectrum to determine an auto correlation function for the pulse train.

In some embodiments of the present invention, the probability of detecting a photon per pulse is less than 1%. In some embodiments of the present invention, the probability of detecting a photon per pulse is less than 0.5%. In some embodiments of the present invention, the probability of detecting a photon per pulse is less than 0.1%.

In some embodiments of the present invention, the pulse train transmits data at a data transmission rate at or in excess of about 10 Gbps. In some embodiments of the present invention, the pulse train transmits data at a data transmission rate at or in excess of about 40 Gbps. In some embodiments of the present invention, the pulse train transmits data at a data transmission rate at or in excess of about 160 Gbps.

In some embodiments of the present invention, determining the time lapse comprises determining the time lapse to an accuracy equal to or less than about 10 picoseconds. In some embodiments of the present invention, determining the time lapse comprises determining the time lapse to an accuracy equal to or less than about 2 picoseconds.

There is further provided, in accordance with an embodiment of the present invention, a pulse analyzer for characterizing optical pulses in a pulse train comprising: at least one photosensor that generates an output signal responsive to a single photon incident thereon; a light director that receives light from each optical pulse in the pulse train and directs light from the optical pulse to each of the at least one photosensor with an intensity such that the probability of a photon reaching a photosensor of the at least one photosensor from an optical pulse is substantially less than one; a clock that is turned on responsive to an output signal from the at least one photosensor if the clock is off and is turned off responsive to the signal if the clock is on; and a processor that receives at least one signal responsive to a time lapse between a time at which the clock is turned on and subsequently turned off for each of a plurality of times at which the clock is turned and uses the time lapses to determine a characteristic of the optical pulses.

Optionally, the processor determines from the signals for each of a plurality of times at which the clock is turned on a time lapse between the time that the clock is turned on and a next subsequent time at which the clock is turned off and uses the determined time lapses to characterize the pulses.

In some embodiments of the present invention, the pulse train is characterized by a constant pulse repetition period and each optical pulse is temporally located in a same position of its own repetition period. Optionally, the processor determines a time interval for each time lapse which is equal to the time lapse minus a time equal to the repetition period times a number of repetition periods between the repetition periods of the pulses from which the first and second photons are detected and uses the plurality of determined time intervals to characterize the pulses.

Optionally, the processor uses the plurality of time intervals to determine a probability density distribution for the time intervals. Optionally, the processor determines a Fourier transform of the probability density distribution and uses the Fourier transform to characterize the pulses. Optionally, the processor uses the Fourier transform to determine a power spectrum for the pulses. Optionally, the processor uses the power spectrum to determine an autocorrelation function for the pulse train.

In some embodiments of the present invention, the at least one photosensor comprises a first and a second photosensor and wherein an output signal generated by the first photosensor turns on the clock and an output signal from the second photosensor turns off the clock. In some embodiments of the present invention, the at least one photosensor operates in a Geiger mode.

In some embodiments of the present invention, the clock comprises a time to digital converter.

In some embodiments of the present invention, the probability of a photon reaching a photosensor per optical pulse is less than 1%. In some embodiments of the present invention, the probability of a photon reaching a photosensor per optical pulse is less than 0.5%. In some embodiments of the present invention, the probability of a photon reaching a photosensor per optical pulse is less than 0.1%.

In some embodiments of the present invention, the pulse train transmits data at a data transmission rate at or in excess of about 10 Gbps. In some embodiments of the present invention, the pulse train transmits data at a data transmission rate at or in excess of about 40 Gbps. In some embodiments of the present invention, the pulse train transmits data at a data transmission rate at or in excess of about 100 Gbps.

### BRIEF DESCRIPTION OF FIGURES

Non-limiting examples of embodiments of the present invention are described below with reference to the figure attached hereto and listed below. Dimensions of components and features shown in the figure are chosen for convenience and clarity of presentation and are not necessarily shown to scale.

FIG. 1 schematically shows a pulse analyzer characterizing optical pulses in a pulse train, in accordance with an embodiment of the present invention.

### DETAILED DESCRIPTION OF EXEMPLARY EMBODIMENTS

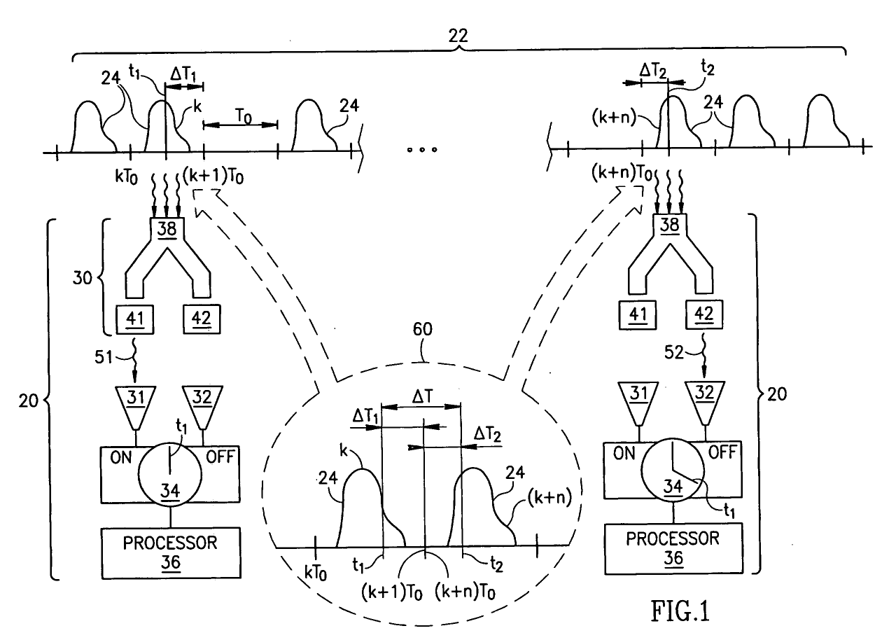

FIG. 1 schematically shows a pulse analyzer 20 analyzing pulses in an optical pulse train 22, only a portion of which is shown, comprising optical pulses 24. Pulse train 22 is characterized by a pulse repetition period Tₒ and each pulse 24 is transmitted in its own pulse repetition period and has a pulse width T≦Tₒ and an intensity I(t) as a function of time t. Each pulse 22 is assumed to start following a same delay time from a time at which its pulse repetition period begins. I(t) is assumed to be equal to zero for t<0 and t>T, and without loss of generality, the intensity of each pulse is assumed to be normalized so that

$${\int }_{0}^{T} I ( t ) ⅆ t = 1.$$

Pulse analyzer 20 receives light from each pulse 24 in pulse train 22 and is schematically shown in FIG. 1 receiving light from two different pulses 24 in the pulse train. At time t₁ pulse analyzer 20 is shown receiving light from a pulse 24, labeled “k”, in a k-th repetition period of pulse train 22. At a time t₂, pulse analyzer 20 is shown receiving light from a pulse 24, labeled “(k+n)” in a (k+n)-th repetition period of the pulse train.

Pulse analyzer 20 optionally comprises a light director 30 first and second photosensors 31 and 32 respectively, a clock 34 and a processor 36. Clock 34 is optionally any of various devices known in the art such, as an appropriate Time to Digital Converter (TDC) for determining a time interval with high resolution. Light director 30 optionally comprises an optical coupler 38 and first and second optical attenuators 41 and 42 respectively. Light received by pulse analyzer 20 from each pulse 24 is received by optical coupler 38, which directs a portion of the received light so that it is incident on first attenuator 41 and a second portion of the received light so that it is incident on second attenuator 42. Light that is transmitted by attenuator 41 is incident on first photosensor 31 and light that is transmitted by second attenuator 42 is incident on second photosensor 32.

Photosensors 31 and 32 operate in a Geiger detection mode and each generates an output signal responsive to a single photon incident thereon. Photosensors 31 and 32 may be avalanche photodiodes (APDs), metal-semiconductor-metal (MSM) photodiodes, or photomultiplier tubes (PMT). Commercially available photosensors suitable for the practice of the present invention are, by way of example, a photosensor designated “FPD15U51KS” marketed by Fujitso of Japan and a photosensor designated “30733E” marketed by EG & G of the US. For photosensor FPD15U51KS operating in the Geiger mode, a signal generated by the photosensor responsive to a photon incident on the photosensor can be used to determine a time of arrival of the photon at the photosensor to within a picosecond.

Attenuation provided by first attenuator 41 is adjusted so that a probability of more than a single photon from a pulse 24 reaching first photosensor 31 is much smaller than one. Similarly, attenuation provided by attenuator 42 is adjusted so that the probability of more than a single photon from a pulse 24 reaching second photosensor 32 is much smaller than one. If a rate at which photons reach first photosensor 31 for a given intensity of light is equal to a factor “α” times the given intensity, then a probability of a photon reaching the first photosensor at a time t during a pulse 24 is αI(t). The condition that a probability of more than a single photon reaching the first photosensor during a pulse 24 requires that αTₒ<<1. In some embodiments of the present invention, attenuation provided by attenuator 41 is adjusted so that a probability of a photon reaching first photosensor 31 from a pulse 24 is less than about 1%. Optionally, the attenuation is adjusted so that the probability of a photon reaching photosensor 31 is less than about 0.5%. Optionally, the attenuation is adjusted so that the probability of a photon reaching photosensor 31 is less than about 0.1%.

Similarly, if a rate at which photons reach second photosensor 32 for a given intensity of light is equal to a factor “β” times the given intensity, then a probability of a photon reaching second photosensor 32 at a time t is βI(t) and βTₒ<<1. In some embodiments of the present invention, attenuation provided by attenuator 42 is adjusted so that a probability of a photon reaching first photosensor 32 from a pulse 24 is less than about 1%. Optionally, the attenuation provided by attenuator 42 is adjusted so that the probability of a photon reaching photosensor 31 is less than about 0.5%. Optionally, the attenuation provided by attenuator 42 is adjusted so that the probability of a photon reaching photosensor 31 is less than about 0.1%.

An output pulse from first photosensor 31 turns on clock 34, optionally after resetting the clock, if the clock is not already on. An output pulse from second photosensor 32 turns off clock 34 if the clock is not already off. An output pulse from first photosensor 31 that reaches clock 34 while the clock is on does not turn off the clock. An output pulse from second photosensor 32 that reaches clock 34 while the clock is off does not turn on the clock. Each time clock 34 is turned on and subsequently turned off, processor 36 determines a time lapse between the time that the clock was turned on and the time that the clock was turned off and stores the time lapse for processing to characterize pulses 24 as described below.

In some embodiments of the present invention, attenuation provided by attenuators 41 and 42 are adjusted independently of each other so that a is adjusted independently of β. Independent adjustment of α and β can be used to compensate for differences in sensitivities of photosensors 31 and 32. In addition, it is believed that error in a determination of a time lapse between a time at which clock 34 is turned on and a time at which the clock is turned off, due to jitter in the time at which the clock is turned on, can be reduced by adjusting attenuation provided by attenuator 41 so that a is substantially smaller than β.

By way of example, in FIG. 1 at time t₁ clock 34 is assumed to be off and a single photon 51 from pulse 24 (pulse k) in the k-th repetition period is schematically shown incident on first photosensor 31. In response to photon 51, first photosensor 31 generates a signal that turns on clock 34, after optionally resetting the clock. It is noted that it is only by chance that photon 51 is incident on first photosensor 51 and not on second photosensor 52. However, were photon 51 incident on second photosensor 32 rather than first photosensor 31, photon 51 would have had no effect on the clock. Clock 34 would have remained off, still waiting to be turned on by a photon incident on first photosensor 31.

At time t₂ a single photon 52 from pulse 24 in the (k+n)-th repetition period is schematically shown incident on second photosensor 32 and the photosensor generates an output signal responsive thereto. The photon incident on second photosensor 32 at time t₂ is a first photon incident on the second photosensor 32 since time t₁. Therefore, since time t₁ clock 34 has been on continuously and the signal generated by the second photosensor turns off clock 34. It is noted that were photon 52 incident on first photosensor 31 rather than second photosensor 32, photon 52 would have had no effect on clock 34 and the clock would not have been turned off. Clock 34 would have remained on and waiting to be turned off by a photon incident on second photosensor 32.

Processor 36 receives at least one signal from clock 34 responsive to a time difference between t₂ and t₁ and determines therefrom an autocorrelation interval ΔT=ΔT₁+ΔT₂. ΔT₁ is equal to a time period from t₁ to the time (k+1)Tₒ at which the (k+1)-th repetition period begins. (For convenience and simplicity, the k-th repetition period begins at a time kTₒ rather than (k−1)Tₒ.) ΔT₂ is equal to a time period from the beginning of the (k+n)-th repetition period at time (k+n)Tₒ to the time t₂. The relationship between ΔT, ΔT₁, ΔT₂ and optical pulses 24 in the k-th and (k+n)-th repetition periods is graphically shown in inset 60. In inset 60 the k-th and (k+n)-th repetition periods and their respective pulses 24 are placed contiguous to each other with the witness lines for times (k+1)Tₒ and (k+n)Tₒ shown in pulse train 22 coinciding at a witness line marked with both times (k+1)Tₒ and (k+n)Tₒ. For clarity of presentation the elements and features of the k-th and (k+n)-th repetition periods and their respective pulses 24 are magnified relative to their sizes in pulse train 22.

It is noted, that it is not necessary to turn on clock 34 at time t₁ and turn off the clock at time t₂ to determine a time difference between times t₂ and t₁ and therefrom an autocorrelation interval ΔT. In some embodiments of the present invention, clock 34 is normally on. Clock 34 is turned off at time t₁ and subsequently turned on at time t₂ by photons incident respectively on first and second photosensors 31 and 32. A time difference between times t₁ and t₂ is determined by a duration for which clock 34 is off between times t₁ and t₂.

Pulse analyzer 20 accumulates a plurality of autocorrelation intervals ΔT for pulse train 22 and generates a probability density function f(ΔT) from the accumulated intervals. By way of example, assuming that αTₒ=βTₒ=10⁻³ and that Tₒ=100 picoseconds, photosensors 31 and 32 have counting rates of about 10 MHz and pulse analyzer 20 will accumulate autocorrelation intervals at a rate of about 5 MHz. The function f(ΔT) is related to, and in accordance with an embodiment of the present invention, is used to determine the power spectrum for pulses 24 as described below.

In some embodiments of the present invention, a single photosensor is used in place of first and second photosensors 31 and 32. A first photon incident on the photosensor turns on clock 34 while a subsequent second photon incident on the photosensor turns off the clock. However, for such embodiments of the present invention, a time difference between times t₂ and t₁ must be larger than a recovery time of the photosensor for the photosensor to generate a signal that turns off clock 34 responsive to a photon incident on the photosensor at time t₂. As a result, an upper limit to a frequency with which clock 34 can be turned on and off and therefore of a data acquisition rate at which autocorrelation intervals ΔT can be acquired is limited to 1/T_{R}, where T_{R} is the recovery time of the photosensor. Using two photosensors, in accordance with an embodiment of the present invention, can enable clock 34 to be turned off at times that are substantially independent of the recovery time of the photosensors and permits thereby data acquisition rates that are greater than 1/T_{R}.

For photon 51 that turns on clock 34, which is detected by first photosensor 31 during the k-th repetition period, a probability that the photon is detected in a time period dt at a time tₖ from the beginning of the repetition period is I(tₖ)dt. For photon 52, which is detected by second photosensor 32 during the (k+n)-th repetition period, that turns off clock 34, a cumulative probability that the photon is detected at a time less than or equal to ΔT₂ from the beginning of the (k+n)-th repetition period is

$${\int }_{0}^{Δ {T}_{2}} I ( {t}_{( k + n )} ) ⅆ {t}_{( k + n )} .$$

Replacing ΔT₂ with ΔT₂=(ΔT−ΔT₁)=ΔT−(Tₒ−tₖ) we can write

$${\int }_{0}^{Δ {T}_{2}} I ( {t}_{( k + n )} ) ⅆ {t}_{( k + n )} = {\int }_{0}^{Δ T - ( {T}_{o} - {t}_{k} )} I ( {t}_{( k + n )} ) ⅆ {t}_{( k + n )} .$$

The latter integral is the cumulative probability that for a given time tₖ at which photon 51 is detected, the autocorrelation interval is less than or equal to ΔT. A cumulative probability for ΔT, “F(ΔT)” for all possible values for tₖ can therefore be written

$$F ( Δ T ) = {\int }_{o}^{{T}_{o}} I ( {t}_{k} ) ⅆ {t}_{k} {\int }_{0}^{Δ T - ( {T}_{o} - {t}_{k} )} I ( {t}_{( k + n )} ) ⅆ {t}_{( k + n )} .$$

Taking the derivative of F(ΔT) with respect to ΔT gives the probability density function,

$$f ( Δ T ) = {\int }_{o}^{{T}_{o}} I ( {t}_{k} ) I ( Δ T + {t}_{k} - {T}_{o} ) ⅆ {t}_{k} = {\int }_{- ∞}^{∞} I ( {t}_{k} ) I ( Δ T + {t}_{k} - {T}_{o} ) ⅆ {t}_{k} ,$$

since for t<0 and t>Tₒ, I(t)=0.

For convenience, let t=tₖ and y=(ΔT−Tₒ), then

$$f ( y + {T}_{o} ) = {\int }_{- ∞}^{∞} I ( t ) I ( t + y ) ⅆ t .$$

Let the Fourier transform of the intensity I(t) be represented by

$$I ( ω ) = {\int }_{- ∞}^{∞} I ( t ) {ⅇ}^{- j ω t} ⅆ t .$$

Then

$$f ( Δ T ) = f ( y + {T}_{o} ) = {\int }_{- ∞}^{∞} {\int }_{- ∞}^{∞} I ( ω ) {ⅇ}^{j ω t} I ( t + y ) ⅆ t ⅆ ω .$$

Letting u=−(t+y), the double integral can be written

$$\begin{matrix}{\int }_{- ∞}^{∞} I ( ω ) I ( - u ) {ⅇ}^{- j ω u} {ⅇ}^{- j ω y} ⅆ u ⅆ ω = {\int }_{- ∞}^{∞} I ( ω ) I ( - ω ) {ⅇ}^{- j ω y} ⅆ ω \\ = {\int }_{- ∞}^{∞} {\vert I ( ω ) \vert}^{2} {ⅇ}^{j ω y} ⅆ ω .\end{matrix}$$

Remembering that y+Tₒ=ΔT, we can write

$$f ( y + {T}_{o} ) = f ( Δ T ) = {\int }_{- ∞}^{∞} {\vert I ( ω ) \vert}^{2} {ⅇ}^{- j ω {T}_{o}} {ⅇ}^{- j ω Δ T} ⅆ ω .$$

The probability density function f(ΔT) that processor 36 generates from accumulated values for ΔT is therefore seen to be equal to the inverse Fourier transform of the function |I(ω)|²e^{-jωT}o, which in symbols may be written f(ΔT)=F⁻¹{|(ω)|²e^{-jωT}o} where F−¹ represents the inverse Fourier transform. The probability density function f(ΔT) provides a phase shifted power spectrum |I(ω)|² of I(t), in symbols, |I(ω)|²=F{f(ΔT)}e^{-jωT}o. In accordance with an embodiment of the present invention, processor 36 determines the power spectrum of I(t) that characterizes optical pulses 24 from the Fourier transform of f(ΔT). Since the power spectrum of a temporal waveform is a Fourier transform of the autocorrelation function of the waveform, in some embodiments of the present invention, the power spectrum determined from f(ΔT) is used to determine the autocorrelation function of optical pulses 24.

It is noted that while determining the power spectrum of pulse train 22 assumes a constant value for the repetition period Tₒ, it is possible to determine a power spectrum for characterizing the pulses of an optical pulse train for a varying repetition period. If the pulses have substantially a same shape and onset times for each repetition period and for each pulse relative to the onset time of its repetition period can be determined, suitable autocorrelation intervals can be determined from which to determine a power spectrum.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for characterizing optical pulses in a pulse train wherein pulses in the pulse train have substantially a same shape, the method comprising:
a) detecting photons from pulses in the pulse train with a probability of detecting a photon per pulse being substantially less than one;
b) determining a time lapse between detection of a first photon and a subsequent second photon and storing the time lapse in a memory;
c) repeating b to accumulate a plurality of time lapses; and
d) using the plurality of time lapses to characterize the pulses.

2. A method for characterizing optical pulses according to claim 1 wherein the pulse train is characterized by a constant pulse repetition period and each optical pulse is located in a same temporal position of its own repetition period.

3. A method for characterizing optical pulses according to claim 2 wherein using the plurality of time lapses comprises determining a time interval for each time lapse, which time interval is equal to the time lapse minus a time equal to the repetition period times a number of repetition periods between the repetition periods of the pulses from which the first and second photons are detected and using the plurality of determined time intervals to characterize the pulses.

4. A method according to claim 3 wherein using the plurality of time intervals comprises determining a probability density function for the time intervals.

5. A method according to claim 4 and comprising determining a Fourier transform of the probability function.

6. A method according to claim 5 and comprising using the Fourier transform to determine a power spectrum for the pulses.

7. A method according to claim 6 and comprising using the power spectrum to determine an auto correlation function for the pulse train.

8. A method according to claim 1 wherein the probability of detecting a photon per pulse is less than 1%.

9. A method according to claim 8 wherein the probability of detecting a photon per pulse is less than 0.5%.

10. A method according to claim 9 wherein the probability of detecting a photon per pulse is less than 0.1%.

11. A method according to claim 1 wherein the pulse train transmits data at a data transmission rate at or in excess of about 10 Gbps.

12. A method according to claim 1 wherein the pulse train transmits data at a data transmission rate at or in excess of about 40 Gbps.

13. A method according to claim 1 wherein the pulse train transmits data at a data transmission rate at or in excess of about 160 Gbps.

14. A method according to claim 1 wherein determining the time lapse comprises determining the time lapse to an accuracy equal to or less than about 10 picoseconds.

15. A method according to claim 12 wherein determining the time lapse comprises determining the time lapse to an accuracy equal to or less than about 2 picoseconds.

16. A pulse analyzer for characterizing optical pulses in a pulse train comprising:
at least one photosensor that generates an output signal responsive to a single photon incident thereon;
a light director that receives light from each optical pulse in the pulse train and directs light from the optical pulse to each of the at least one photosensor with an intensity such that the probability of a photon reaching a photosensor of the at least one photosensor from an optical pulse is substantially less than one;
a clock that is turned on responsive to an output signal from the at least one photosensor if the clock is off and is turned off responsive to the signal if the clock is on; and
a processor that receives at least one signal responsive to a time lapse between a time at which the clock is turned on and subsequently turned off for each of a plurality of times at which the clock is turned and uses the time lapses to determine a characteristic of the optical pulses.

17. A pulse analyzer according to claim 16 wherein the processor determines from the signals for each of a plurality of times at which the clock is turned on a time lapse between the time that the clock is turned on and a next subsequent time at which the clock is turned off and uses the determined time lapses to characterize the pulses.

18. A pulse analyzer according to claim 17 wherein the pulse train is characterized by a constant pulse repetition period and each optical pulse is temporally located in a same position of its own repetition period.

19. A pulse analyzer according to claim 18 wherein the processor determines a time interval for each time lapse which is equal to the time lapse minus a time equal to the repetition period times a number of repetition periods between the repetition periods of the pulses from which the first and second photons are detected and uses the plurality of determined time intervals to characterize the pulses.

20. A pulse analyzer according to claim 19 wherein the processor uses the plurality of time intervals to determine a probability density distribution for the time intervals.

21. A pulse analyzer according to claim 20 wherein the processor determines a Fourier transform of the probability density distribution and uses the Fourier transform to characterize the pulses.

22. A pulse analyzer according to claim 21 wherein the processor uses the Fourier transform to determine a power spectrum for the pulses.

23. A pulse analyzer according to claim 22 wherein the processor uses the power spectrum to determine an autocorrelation function for the pulse train.

24. A pulse analyzer according to claim 16 wherein the at least one photosensor comprises a first and a second photosensor and wherein an output signal generated by the first photosensor turns on the clock and an output signal from the second photosensor turns off the clock.

25. A pulse analyzer according to claim 16 wherein the at least one photosensor operates in a Geiger mode.

26. A pulse analyzer according to claim 16 wherein the clock comprises a time to digital converter.

27. A pulse analyzer according to claim 16 wherein the probability of a photon reaching a photosensor per optical pulse is less than 1%.

28. A pulse analyzer according to claim 27 wherein the probability of a photon reaching a photosensor per optical pulse is less than 0.5%.

29. A pulse analyzer according to claim 27 wherein the probability of a photon reaching a photosensor per optical pulse is less than 0.1%

30. A pulse analyzer according to claim 16 wherein the pulse train transmits data at a data transmission rate at or in excess of about 10 Gbps.

31. A pulse analyzer according to claim 16 wherein the pulse train transmits data at a data transmission rate at or in excess of about 40 Gbps.

32. A pulse analyzer according to claim 16 wherein the pulse train transmits data at a data transmission rate at or in excess of about 160 Gbps.
